(19) United States
(12) Patent Application Publication
(10) Pub. No.: US 2007/0094093 A1
(43) Pub. Date: Apr. 26, 2007

(54) Method of producing individualized printed products

(76) Inventors: Holm Hallbauer, Dresden (DE); Mark Hallbauer, Dressden (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/342,325

(22) Filed: Jan. 27, 2006

(30) Foreign Application Priority Data
Oct. 20, 2005 (DE) 10 2005 050 355.1

(51) Int. Cl. G06Q 30/00

(52) U.S. Cl. 705/26

(57) ABSTRACT

The present invention relates to a method for producing individualized printed products by analyzing target person-relevant data utilizing machine learning which comprises the steps of: collecting individualized data, evaluating the individualized data based on a learning classification algorithm as well as generating an evaluation, producing individualized printed products based on the evaluation. The invention hereby addresses the task of enabling the manually infeasible automated production of individualized printed products per target customer in large quantity, as used in particular in the selling of telephone directory ads.

### BACKGROUND OF THE INVENTION

1. Field of the Invention

The present invention relates to a method of producing individualized printed products by analyzing customer-relevant data utilizing machine learning.

2. Description of the Related Art

When printing telephone directories, in particular those which are known as business directories (yellow pages), the problem arises each year or at each new updating cycle of determining the entry dimensions—i.e. ad sizes—per company purchasing an entry. Business directories contain an alphabetical listing of companies along with their address and telephone number, or a listing according to a different sorting criterion, for example thematic. Entries can be a simple single-line entry, or can be an elaborately designed ad-like entry containing not only basic information such as company name, address and telephone numbers but also a wide spectrum of additional information. Such additional information usually concerns products or services offered. Ad-like entries in business directories can thus have considerable advertising effect for the respective company, including contributing to the building of its image. For example, a relatively small company can draw distinctive attention with a disproportionately large entry in a business directory. In contrast, a singleline entry for a large and well-known company can be quite damaging to its image. It is important to realize in this context that the internet and the marketing and advertising opportunities it offers have given rise to a development which threatens to radically undermine the traditional advertising mechanisms of business directories. The business directory industry is thus up against a classic situation of “disruptive technology,” against which the industry needs to develop the appropriate defense strategy.

The following will treat the terms “entry” and “advertisement” and “business directory” and “telephone directory” as synonymous.

So as to optimize sales and profits, telephone directory companies are additionally desirous of receiving preferably large-format ads and entries from each company for inclusion in its telephone directory. It is thereby the task of a telephone directory salesperson to sell a preferably large ad or entry to each company listed in his/her respective business directory. Since most areas (geographical or thematic) have several competitive business directories while business telephone customers only have a limited budget to spend on telephone book advertisements, each telephone directory publisher strives to get the respectively greatest number of large ads in its business directory.

The sales process mentioned above follows the rules of traditional selling, whereby for all purposes, none of the salespeople from the various different telephone directory publishers has any palpable advantage over the others. Typical sales aids are hereby glossy brochures of the respective telephone directory publishers and, in the best case scenario, traditional DIN A4 (approx. 8½×11) flip charts which can be set up and flipped through. Some telephone directory publishers have also tried equipping their sales reps with laptop computers and the respective presentations. Yet the salespeople are usually more encumbered than supported by the technology. The customer's attention is directed to the technical equipment and the salesperson's full attention to the customer is lost. Additionally, there are no sales aids known at present which support the unique, specific situation of an individual customer in bulk sales such as telephone directory ad sales.

Explicit reference is made to this applicant's “Sales Aid” application of the same filing date, the contents of which are to be regarded as being explicitly included here by reference.

### SUMMARY OF THE INVENTION

The problem which the present invention addresses is the enabling of automated mass-production of individual printed products per target customer, which would be manually infeasible to produce, as used in particular when selling space in telephone directories.

In one embodiment, a method of producing individualized printed products by analyzing target person-relevant data utilizing machine learning comprises collecting individualized data, evaluating the individualized data based on a learning classification process as well as generating an evaluation, and producing individualized printed products based on evaluation.

Computer systems and computer program products implementing this method are also provided.

### BRIEF DESCRIPTION OF THE DRAWINGS

The invention will be described in the following by illustrative embodiments which make further descriptive reference to the drawings. Shown are:

FIG. 1—a general view of the method according to the invention;

FIG. 2—a partial process of an embodiment for producing individualized printed products;

FIG. 3—a further partial process of the inventive method for generating the customer classes;

FIG. 4—a further partial process of assigning the individualized customer data to customer classes for a further embodiment;

FIG. 5—the use of the optimizing process as part of an embodiment; and

FIG. 6—a preferred embodiment of the inventive method in which data is recorded on the individualized printed product as well as at least one data value being transmitted back to a portable communication device.

### DETAILED DESCRIPTION OF THE INVENTION

What is involved in some embodiments in terms of the individualized printed products are printed sales aids for salespeople selling advertising space. The products have a unique geometric shape which is filled with text and images on an individual case basis. In this context, target person-relevant data refers to that which is compiled specifically for a particular contact person at a potential customer. The term “machine learning” is to be understood in this context as a self-optimizing process for the method, one which generates continually better results upon each new cycle based on automatic changes made to valuation criteria. A result is better when there is a higher probability of making an ad sale or when higher individual or total sales are achieved.

The particular advantage of the inventive method is that a large number of individualized data is collected and evaluated individually and collectively such that a large number of individualized printed products—in particular printed sales aids for telephone directory salespeople—can be produced for various different target persons or target customers. Manual production of a great number of individualized sales aids within one advertising sales campaign is prohibitive for reasons of volume. For this reason, standardized sales aids; i.e., identical for each customer, have always been used in the past, if at all. It is well-documented that generalized sales aids are far less successful than those prepared individually for a specific target person. Also, manual methods do not in principle allow automated self-optimizing or machine learning so as to achieve better results; i.e., a higher probability of making a sale or higher sales in sequential sales campaigns where the same procedure is re-used each time. Other branches of industry can also make use of the inventive method such as the insurance industry in the selling of insurance policies or banks in the selling of financial investment or annuity products. Generally speaking, the inventive method can be utilized wherever a customizable product or a customizable service is being sold to a target person on an individual basis within the scope of a larger sales campaign. A typical sales campaign in this regard lasts about six weeks. A campaign is characterized by determining the target customers, addressing the selected target customers with promotional materials and ultimately evaluating the results. Not all branches of industry commonly include pre- and post-processing stages—i.e. target customer selection and follow-up—in their campaign periods. In these cases, a campaign can also be longer. On the other hand, there are also micro-campaigns in which the advertising measures are applicable only for a few days, sometimes even only a few hours. Traditional customer selection procedures as well as the contact and evaluation will then be completely thwarted. Even with campaigns lasting six weeks, manual procedures are thoroughly overtaxed and impractical.

The process step of “evaluating individualized data” also encompasses forming a number of prototype classes of model customers. Model customers in this sense are idealized customer types which emerge during the traditional selling process. The advantage to creating such prototype classes—by classification algorithm—lies in the fact that a large number of individual customers can be mapped within these prototype classes such that when further processing the data, while the information can be individually related to a specific customer, is it also possible to subsequently achieve a more abstract processing based on the characteristics of the various classes. In this context, abstract processing refers to, for example, being able to treat whole groups of customers in exactly the same way, that identical key control parameters (e.g. company sales, company type, previous ad sizes, special preferences, industry, etc.) are sent on to the next process step. Among other things, this can mean the use of the same printing template to generate individual printed products customized to one specific target person. Printing templates in particular refer to master templates having the overall same layout yet which can be individually printed with content specific to the respective target person. This thus combines both the advantages of an utterly individualized aspect as well as the wholly traditional customer group-based approach. Total expenditures can hereby be optimized.

The mapping of individualized customer data to the prototype customer classes is hereby an N:1 process. In other words, the number of customers is typically greater than the number of prototype classes. The ruleset which forms the basis for the process, yet which can be modified at any time, is designed such that a certain combination of characteristics from the individualized customer data always leads to only one single prototype class. The ruleset governing the assigning of the individualized customer data to the individual prototype classes can be reformulated for each campaign. This even allows easy creation of ad campaigns for special events. For example, if a special event will be taking place in the catchment area of a retailer or service provider (e.g. a sporting event near a restaurant), a program guide can be printed explicitly for this event which also contains ads from local retailers or service providers. The following prototype class attributes to be incorporated when defining basic prototype classes are given as examples: Type: Restaurant; Type: Fan souvenir shop; Type: Pharmacy; Type: Taxi/Transportation company: Type: Hotel/Motel, as well as the geographical location. The versatile applicability here goes far beyond using the method as a basis for redesigning a business telephone directory and the related selling of ads. Creating other printed products with the inventive method is just as readily conceivable.

When collecting individualized data—in particular individualized target person-relevant data—both structured (e.g. sales, staff size, past ad sales; i.e., all information which can be depicted in precise numbers and terms) as well as unstructured data (includes images, photos, scanned ads; i.e., all information not constituting characteristic text/number information) is collected and stored in a database. Unstructured data here is basically that which is only available in the form of printed information, usually image-based information as a combination of image and text, e.g. scanned ads. Using a special text recognition program (based on OCR technology; OCR=optical character recognition), some structured data can be retrieved from the unstructured data in the form of text (e.g. company name, street and location information, email address, website, placement information), numbers (telephone number, actual address, etc.) as well as isolated image elements such as a company logo, for example. Structured data here is in particular that which can be processed in traditional data processing systems as a combination of numbers and characters mapped into the individual fields of a database system. All the data related to a potential customer can be clearly linked. This can be done, for example, through the associated telephone number or address and name of the company. Other abstract classification criteria will be known to those experts familiar with databases. Thus, all different types of information is addressable using a unique access key.

A plurality of information sources are conceivable as data sources for the structured and unstructured data. Apart from the structured/unstructured dimension, data sources can also be divided into internal/external dimensions. Data and information sources thereby include: telephone/business directories—in particular past directories from the same or competitive publishers, industry data (also localized and geographically-classified marketing data) obtainable from special industry service providers, the historical data of a target company, activity-based data, competitor data, in particular the telephone directory ads of competitors, company indicators, financial/credit rating data and/or past ad sales, time-related data such as seasonal sales for a sub-branch, natural catastrophe information (which generates a specific demand for certain services such as, e.g. renovation), etc.

Of course, all combinations of information are conceivable. Being able to take all these different sources of data and information into consideration has the advantage that an ad customer's needs can be predicted with a high degree of probability. The art of the campaign designer lies in determining which information/data sources will be used for a specific campaign. Should the company to be approached be struggling with financial difficulties, the individualized printed product (customer presentation folder) can feature an ad proposal which is more reflective of a lower budget. On the other hand, it is also conceivable to propose an especially large ad to a company which is financially strapped, which sends out the signal that the company is doing above-average financially—in direct contrast to the actual situation. The actual ad proposal made follows from the ruleset on which the prototype class assignment is based and is normally correlated with the conventions of the geographic area and industry.

The advantage of using a combination of structured and unstructured data from print as well as electronic media is that the sum total of information available on a target customer is maximized.

The printed product resulting from the inventive method does not consist of a sequence of standard printed pages, but rather of a special geometrically-formed presentation folder which is designed such that the manner in which the individual pages are folded leads the folder as well as the salesperson and also the customer through a sales pitch in structured fashion. In so doing, information which is intended only for the salesperson is printed so that only he/she can read it, for instance because it appears “upside-down” to the customer, while customer-relevant information is printed so that it's easy for the potential customer to read and appears “upside-down” to the salesperson when the customer and salesperson are sitting directly across from one another, as is the usual case.

The printed information in the presentation folder is hereby in particular designed such that the specific individual customer situation can be directly addressed, whereby the information printed on the presentation folder can be optimized according to variable rules based on the evaluation of the information as well as the available space. This thus advantageously ensures that the customer is not approached with a standard product or a standard sales aid but rather his/her entire situation is taken into consideration.

In particular, the presentation folder presents two alternative proposal scenarios in the form of two different ad sizes. This ensues from the printing being associated with printing templates such that the salesperson initially opens the sales meeting with the larger format ad. The smaller format ad proposal is thereby printed on the reverse side of the presentation folder and is not visible until a page of the presentation folder is turned following the customer rejecting the main offer of the larger format ad. This set-up radically increases the probability of a successful sale. Further provided is that not only one presentation folder can be generated per customer but rather several different presentation folders can be created for each target customer. The salesperson then has a choice of which to use during the actual sales pitch.

The method according to the invention furthermore provides for acquiring success parameters from the sales process. Hereto, the method draws on information on the use of individualized printed products and/or sales aids as feedback information which can then be integrated into the next use of the method during the evaluation process, which serves the creation of an evaluation. Success parameters in this case are to be understood as information on closing an ad sale based on a specific customer brochure, individual sales, as well as other parameters assigned to a pre-defined campaign. The advantage of recovering this information is that the self-optimizing learning process can now be initiated. Parameter feedback enables statements to be made on the success of certain types of individualized printed products and/or sales aids. Correlations can thereby be made on diverse counts, conceivably including: company size-ad size, staff size-ad size, salesperson type-ad size, regional economic situation-discount level, salesperson type-discount level. These correlations are to be understood as examples of virtually any other correlation analysis. Also conceivable is correlating the parameters to a presentation folder based on a pre-defined template, from which a salesperson can have several per customer.

After a number of sales campaigns have run successively using the method according to the invention, it becomes possible, when evaluating the individualized data, to draw conclusions from the historical course of the changing parameters and valuation criteria on the one hand and the sales revenues and changes in sales on the other, with respect to particularly favorable sets of parameters. It is additionally possible to change the parameters based on the information obtained so as to increase the probability of success. To analyze the parameters and feed this information back into the rulesets for the evaluation and creation of the individualized printed products, one skilled in the art can make use of known procedures such as case base reasoning, decision tree models or even cluster analyses and statistical variance analyses.

In another preferred embodiment, two further steps are additionally provided. One involves using a special pen to acquire changed or additional individualized data on the individualized printed product. The pen recognizes the additions made and saves them in the pen. Forwarding of the newly-acquired information to the evaluation step performed on the individualized data then follows. Alternatively, forwarding can also be to the step of creating the individualized printed products. A plurality of alternatives from the field of transmission technology can be used for the path of transmission. Explicit reference is made to the following: the pen transmits the information via a short-range means of communication (e.g. Bluetooth, infrared or even wired) to a portable communication device (e.g. a cellular phone or a wireless-enabled PDA (personal digital assistant)) or to another communication-ready device. The information is routed from there to the evaluation step on the individualized data or to the printing step on the individualized data. A new analysis of new data values can now advantageously ensue. At least one such data value can be a new ad price or another contractual condition.

It is particularly preferred for the step of acquisition (and recognition) of information to be based on pixel information which is printed as a background on the individualized printed product and is only identifiable to the naked eye as a gray background coloring. As such, the paper is all but given interactive properties. The pen immediately and electronically records supplementing information upon changes being made to the individualized printed product. This wholly does away with the need for manual transfer at a computer terminal and the entire process runs substantially more elegantly, faster, and far less susceptible to errors.

The at least one new data value is then advantageously forwarded through a mobile communications network to a portable means of communication where it is ultimately depicted on the ad for the user's further use. A plurality of purely numerical or alpha-numerical characters can also be transmitted. By so doing, the salesperson is put in the position of being able to convert the new information received from the ad customer into a new offer while still in the middle of his/her sales pitch, one which is not based on his or her own estimations but rather on a confirmed revaluation drawing on all data available to the company. This thus eliminates discounts which are too high and the accompanying slump in results or individual conditions based solely on the speculation of a single person. Hence, a closed loop system is realized, one which has previously not been feasible in such a way.

The task facing the invention is moreover solved by a computer system designed to realize the inventive method. Such a computer system is equipped with the necessary mass storage to save the individualized data, means to record the data from the data sources, input and output terminals, communication devices to communicate within a computer network, mobile communication devices for communicating wirelessly and at least one connected printing unit for generating individualized printed products, presentation folders or parts thereof respectively. It is the actual computer system which makes the inventive method viable within the context of a sales campaign. Sales campaigns typically last from several days to several weeks. Creating individualized sales aids without the support of a computer system is inconceivable because of the volume of data sets which must be processed. The above-described computer system thus offers the advantage of realizing the proposed method during the course of a sales campaign lasting several days or weeks.

Lastly, the task on which the invention is based is solved by a computer program product. This computer program product serves the realization of the inventive method on the inventive computer system, which is what makes the inventive method viable in the first place given the limited time frame of a telephone directory ad campaign or other sales campaigns.

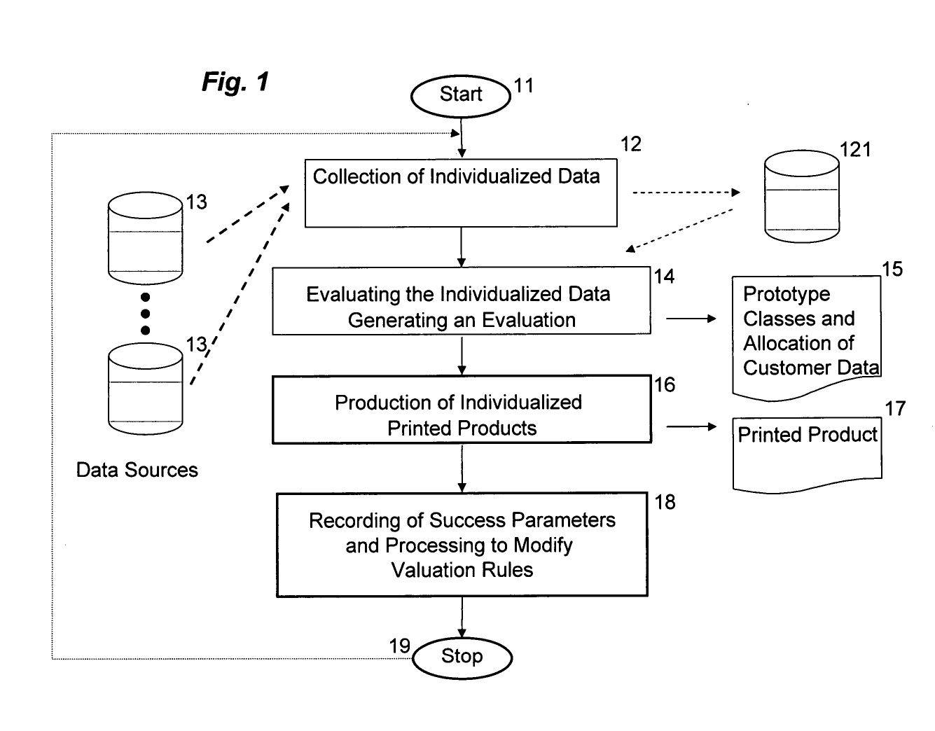

The basic operational sequence of the method is depicted in FIG. 1. Step 11 constitutes the start of a sales campaign. Individualized data on potential customers within a sales territory is collected in a database 121 in Step 12. The accumulating of data is derived from the various different electronic and non-electronic data sources 13. To this end, the non-electronic sources of data are scanned and thus also made available electronically. Examples of non-electronic sources of data for Step 12 would be telephone directories from rival publishers and the ads they contain. All data related to one potential customer is individually addressable in database 121. Addressability can be a function of, for example, the telephone number of the potential customer or also company name together with the associated mailing address. The expert is familiar with this type of and other abstract addressing variants.

When processing unstructured sources of data, automatic recognition of the textual contents—e.g. using OCR—is conceivable. The greater the degree of detail and breadth to the data sources, the better sales revenues can be expected.

The following comes into play as data source content: detailed data on potential customers such as a contact name, company size, product/service offering, targeted customer group, industry and sub-branch information, ad sales information on the potential customers over a historic period of time, sales trends, realized advertising campaigns—in particular, information on current advertising, the layout, the type of ad, the color scheme, sizes, etc.—information about past complaints, information on the financial situation including credit history, a history of the contact person including personal preferences as well as affinity for certain products, the geographical reach of a company—in particular whether the company sells or has branch offices in other geographical regions, information on competitors such as for example names of direct competitors, their sales profile and advertising campaigns as well as the ad history of direct competitors; information about media data which competes with the telephone directory such as, for example, that from newspapers, radio, television, internet and other media which the potential customer may use and also including, for example, spending profiles for such other media. It is moreover conceivable to incorporate general market information such as, for example, a business climate index which is broken down into individual industries or sub-branches. This also relates to the economic efficiency of a specific advertising region, information on the prevailing unemployment rate, as well as evaluations of a specific potential ad customer's class of offer. All of the above-cited detail parameters are to be regarded as examples. The fundamental concept encompasses gathering as much information as possible on a potential ad customer in database 121 which can then be processed further.

Step 14 comprises evaluating the data collected in database 121 as well as generating evaluation parameters. This can be done, for example, using assessment factors for different classes of information in the database. The assessment rules can be set externally and can also be reset for each sales campaign. Typically, an experienced sales-person will specify the rule for weighting the individual assessment parameters at the beginning of a sales campaign.

After an evaluation has been generated, in that the individualized data in database 121 has been assigned weighting parameters, Step 16 effects the production of individualized printed products 17. Same consists of presentation folders having a plurality of different pages. Said printed products 17 are based on specific printing templates designed such that the type of information per presentation folder page is pre-defined. The templates also establish the general layout of the presentation folder. Based on the evaluation in Step 14, the template type is first selected and then the individual pages of presentation folder 17 are filled with the information from database 121. In so doing, the template defines which information is printed at which point within presentation folder 17. When there is more information per page or per portion of page than available printing space, the information which received the highest evaluation parameters in Step 14 is selected. A first embodiment provides for one printed product per potential customer. In this first embodiment, Step 18 can also be skipped, in which case the method ends with Step 19.

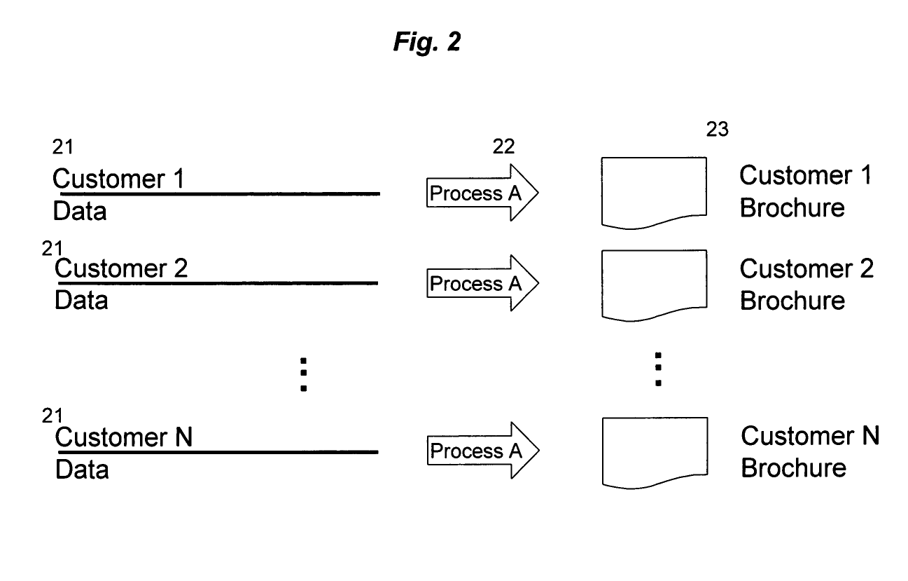

This first embodiment further provides for the individualized customer data in database 121 to be evaluated in a single processing step and to generate printed products 17 in the form of customer brochures 23 from same—as depicted in FIG. 2. For all purposes, evaluation step 14 and generating step 16 occur in one single process step, which is indicated by reference number 22 in FIG. 2 (“Process A”). However, in the case of sizeable data (several thousand customers), it can happen that the externally-supplied valuation rules of Step 14 become very complex and there is then only little or even no provision for additional correlation between customer data and competitor information.

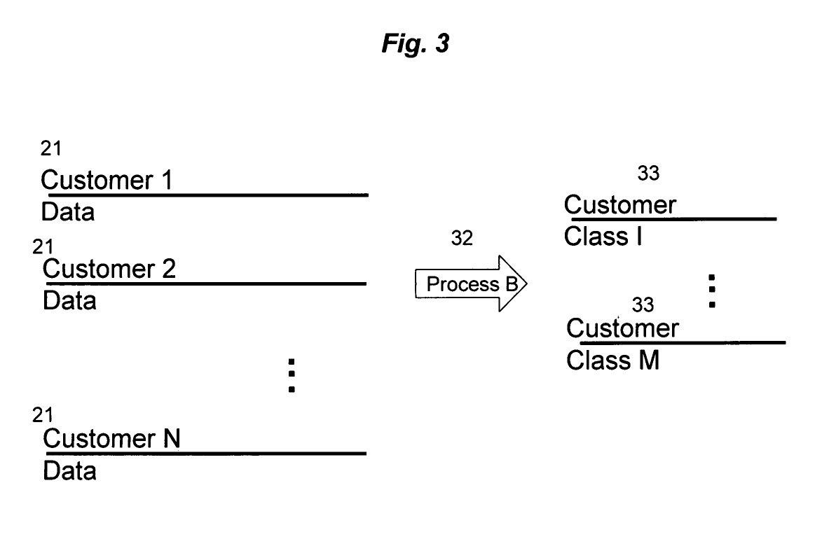

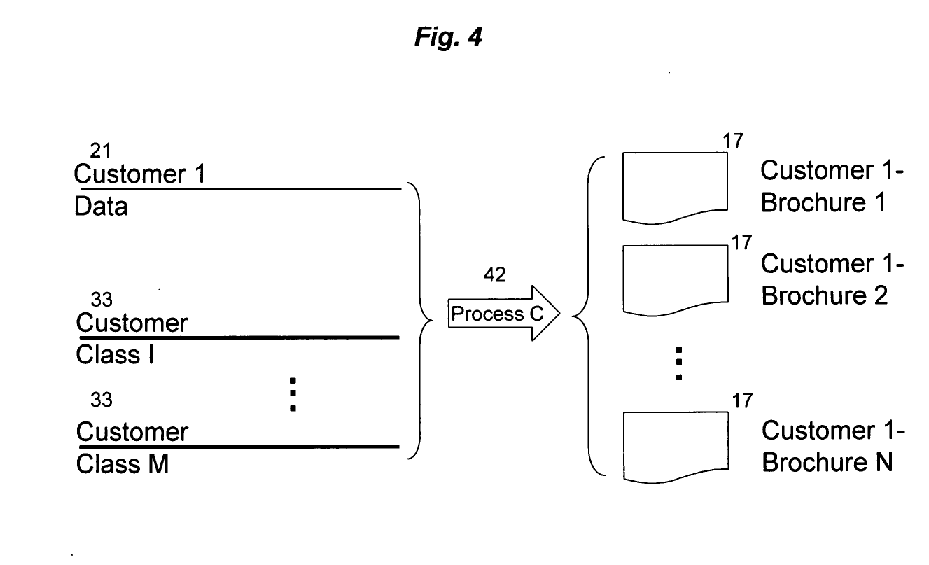

For this reason, a two-stage evaluation process is provided in the inventive method, as represented in FIGS. 3 and 4. First, typical customer classes 33 are created. These customer classes are formed based on, for example, customer size, the customer's branch of business, the competitive environment, geographical information, etc. The rules for establishing customer classes I through M are individually configurable and can be redefined for each sales campaign. Particular deference in this regard is made to the expert knowledge of the sales team. Yet this recourse to manual intervention is not imperative, it merely represents one option. Here the customer classes 33 are configured in such a manner than each instance of individualized customer data in database 121 can be assigned to one of customer classes I through M. A crucial point in this regard is that the number of customer classes is substantially smaller than the number of potential customers in database 121. Good results have been noted using 100 customer classes. Although it is also conceivable to have a lesser number of customer classes. As a rule, the number of potential customers in database 121 to be mapped to these approximately 100 customer classes will amount to several thousand, although it may also number several million. When the relationship between customer classes and customer data changes, the basic method itself does not change. The assigning of customer data 21 to the customer classes 33 is identified with reference numeral 32 (“Process B”) in FIG. 3.

This partial process employed in the second embodiment, described above with respect to FIG. 3, is performed in Step 14 of FIG. 1. The prototype classes and the assigning of customer data 15 as a result of the evaluation can also be seen in FIG. 1. In the second embodiment, the generating 16 of individualized printed products 17 occurs during the partial process depicted in FIG. 4. Same provides for the producing of individualized printed products 17, shown here as different customer brochures, and links the customer data, e.g. Customer 1 data, with the relevant customer classes 33 and the printing templates associated with the respective class in “Process C” 42. Noteworthy about this “Process C” 42 is that not just one brochure 17 is generated per customer but rather a plurality of customer brochures are produced: Customer 1-Brochure 1, Customer 1-Brochure 2, Customer 1-Brochure N. This ultimately gives the salesperson from the telephone directory publisher who calls on the customer the option of which of the customer brochures 17 he/she will actually use during the sales pitch. In generating the individualized printed products, not only does Step 16 comprise the actual printing of individualized customer brochures 17 but they are also classified according to predefined rules, and which information based on which evaluation is printed on the presentation folder at which template location is actually registered and saved. In the system's steady state, only one individualized printed product is ideally needed per target customer.

After having described the general operational sequence of the method above, the individual aspects of the present invention will now be addressed in greater detail. The above-cited rules as used in Steps 14 and 16 can take different priorities into account when generating the customer brochures. Different market and product strategies of the telephone directory provider can be considered here. Among that which might come into consideration would be predefined superordinate rules for a specific sales campaign. Same might concern, for example, the size of the ads to be sold or the color options for an ad or other parameters essential to designing individual ads for a telephone directory. In an economically disadvantaged area, individual discounts associated with certain ad sizes could also be proposed. Or, on the other hand, should the publisher launch a new product line (e.g. cellular phone), he would want all sales to focus on this new product. This can be taken into account when generating an evaluation of the individualized data in Step 14. This changed evaluation effects different content within the templates when generating the individualized printed products or the customer-specific brochures in Step 16.

When generating the individualized printed products or the customer-specific brochures in Step 16, consideration is paid to the fact that the customer is pitched not just one ad type but rather each customer brochure can contain at least two alternative proposals for at least two different individual ads, in particular of different sizes, and thus also contain price differences. The customer does not see both ad alternatives at first, because the special form to the presentation folder prevents the two ad types from being visible at the same time. Sales efforts can thus first be concentrated on selling the higher-value ad and only when that does not work does the salesperson still have the opportunity to present the alternative offer. It is also possible to have a split into a color ad and a less expensive black-and-white ad of the same size. Other combinations are also readily conceivable.

Apart from the ad proposals as mentioned above, the customer brochure templates can contain other fields for printing information. These might comprise, for example: the original data sources, general sales-supporting materials of the publisher, specific selling propositions, other publisher offers, the rules according to which the ad proposals are generated, as well as targeted script guidelines for the sales staff. Even the script guide-lines can be individually developed. If, for example, the customer has always run a small black-and-white ad in the past and the proposal seeks to feature a large-sized color ad in the future, the script guidelines should precisely advance the appropriate arguments. For example, it may be possible that a specific customer's previous presence was under-represented in comparison to his direct competitors. This would be the case when the customer previously ran small black-and-white ads while his three most important competitors were running large-scale colors ads.

The following will discuss the self-leaming characteristics to the method, which requires a computer system for its realization. Reference is made here to Step 18 as depicted in FIG. 1: “Recording of Success Parameters and Processing to Modify Valuation Rules.”

The essential variables in the computer-executed method are: the customers with all customer-relevant data, customer classes, which essentially represent prototype classes of model customers, valuation rules, templates for generating the printed products, the actual brochures as well as the individual salespeople. At the end of an ad sales campaign, information is then provided as to which salesperson was able to sell which customer brochure and at which price. This information is also saved as part of the method for subsequent processing. Storage can be effected in database 121 or in another form. The Step 18 processing encompasses an analysis of the customer situation, represented by the totality of data available for a specific customer, the use of a specific customer brochure, the salesperson, as well as other parameters crucial to the sales process. The results from this analysis are typically saved in tables. Other forms of saving the data are also conceivable. A graphic representation of the results shows an experienced sales manager whether the valuation criteria, necessary for the evaluation of the individualized data in Step 14, needs to be adjusted and whether other focal points must be set when generating an evaluation in a subsequent campaign such that the prototype classes are reformulated and a different allocation of customer data 15 follows. On the other hand, the tabular results can also lead to a direct influencing of Steps 14 and 16. Conceivable here, for example, is the automatic rejecting of specific predefined printing templates which are replaced by more successful ones. In this context, successful means that there is a higher probability of a sale being made between the salesperson and the customer. Additionally conceivable is a reassigning of the target customer-relevant information from database 121 to the templates of printed products 17. It is possible for the sequence of the selling points pitched during the course of the conversation to be sorted not in ascending order but rather in descending order of importance. Other feasible automated adjustment rules encompass a modified color selection for the individual pages of the templates for the individual customer brochures, a greater or less number of customer brochures for a customer from among which the salesperson can choose, the selecting of a different template, etc. One skilled in the art can hereby conceive of any number of different possible combinations.

The renewed application of the method with the new feedback information is represented in FIG. 1 by the dotted line from “Stop” 19 to “Start” 11.

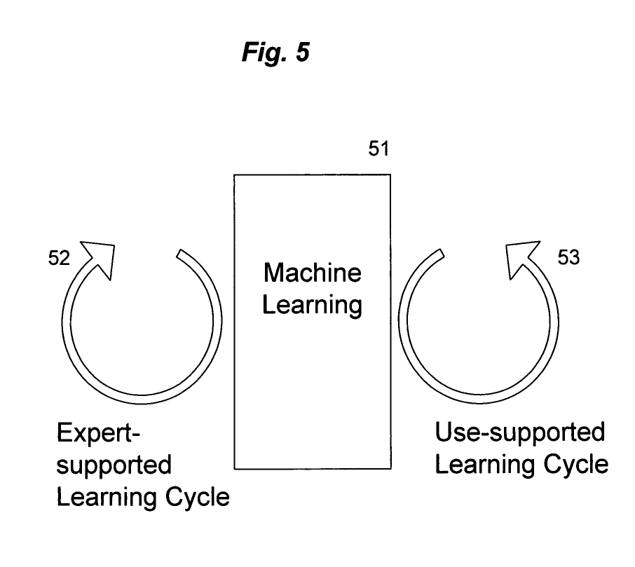

All told, the proposed method provides dual optimization, respectively learning possibilities. On the one hand, the above-described analysis allows a sales expert to modify the valuation rules for creating the customer classes while, on the other, the system which itself executes the method based on the information fed back to it from sales processes can optimize same customized to the salesperson and the customer. These circumstances are depicted in FIG. 5, whereby the abstract learning process 51 is divided into an expert-supported learning cycle 52 and a use-supported leaming cycle 53. The expert-supported leaming cycle thereby relates to the defining of rules for forming the different prototype classes. The use-supported learning cycle on the other hand relates to using the individualized printed products or customer brochures during the sales process. The automatic modification to the visual appearance of the printed products illustrates a self-optimizing process which, in the best case scenario, always leads to the customer deciding in favor of the larger ad. If, for example, it is determined over the course of several ad sales campaigns that a certain salesperson has the greatest selling success with predominantly one certain type of customer brochure, the salesperson will only offer a certain customer or customer type a smaller number—possibly even only one type—of customer presentation folder from a computer-executed method. This approach in turn saves time and money on the sales process.

The expert would use known procedures for the self-optimization of the method on a computer system. This would include autoclassification systems, case-based reasoning, decision tree models, cluster analyses, statistical variance analyses as well as other analytical and optimizing procedures known to one skilled in the art.

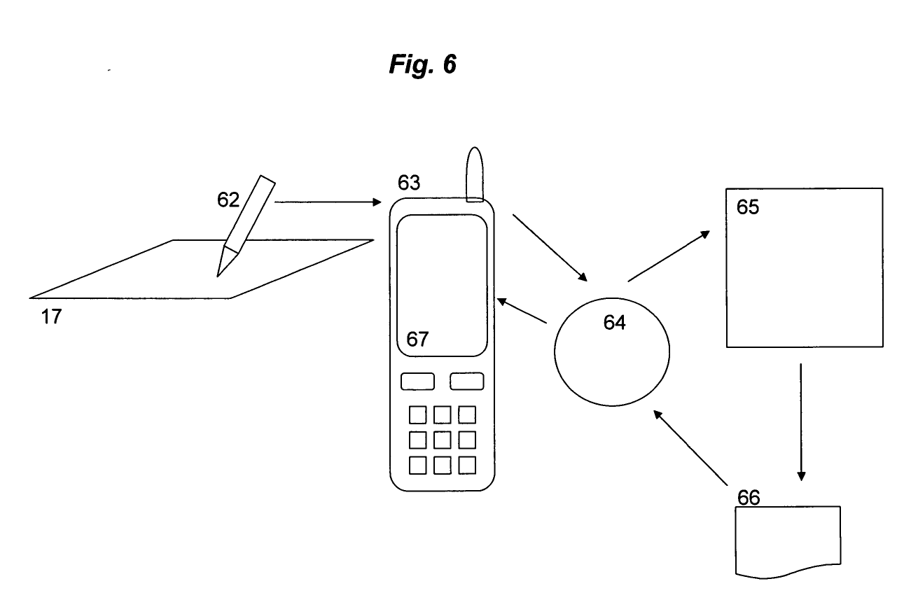

Another embodiment is depicted in FIG. 6. This embodiment relates primarily to a device-supported recording of data from the individualized printed products. Use in the field could proceed as follows: an individual printed product in the form of a promotional flyer is first created, for example to support the selling of ads for telephone business directories using the above-cited method. This flyer is used by a salesperson during a sales meeting with the customer. It could contain an offer, for example, or it could request further details from the customer in the form of a questionnaire. A combination of these two types of information is more the rule on such a flyer. Specific fields and pages are provided on the individualized printed producer/flyer 17 for recording the data. The salesperson takes notes during the meeting with the customer, for example marking checkboxes to record the customer's individual parameters (e.g. company size, customer structure, sales, product range, etc.), or the salesperson jots down comments or additions. In doing so, the salesperson uses an intelligent recorder 62 which can detect which side of the individual printed product/flyer 17 is currently being written on and, in particular, what is being written on which part of the paper. To this end, the paper is provided with wholly specific background pixel information during printing. This background pixel information is expressed as a background pattern of dots which the eye perceives as only a light gray background color. At the same time, pen 62 saves the entries being made on paper 17. In other words, all changes, notes and inscriptions made on flyer 17 are recorded and saved.

At the end of a recording cycle, the information stored in pen 62 (handwritten notes, information on which checkboxes have been checked, arrows pointing to printed elements, etc.) can be transmitted to a cellular phone 63 or other portable communication device such as a wireless-enabled PDA (personal digital assistant) or other small computer. This is either done by touching a special Send field on paper 17, which interprets the tap as a send command, or by pressing a send key on pen 62. Other mechanisms which will trigger the sending of information from the pen to cell phone 63 are also conceivable. Transmission to cell phone 63 can ensue via wired or wireless methods. Transmission via Bluetooth or infrared lends itself well. A call is initiated over the mobile communications network 64 in cell phone 63 by the receipt and a special application program function of cell phone 63. After connecting to a computing center, which is preferably where the program runs a process as described with reference to FIG. 1, the information received by pen 62 is transmitted from cell phone 63 to said computing center (not shown). An assignment is made in the computing center between the individualized printed product/flyer 17, known to the database of the computing center, and the information received. In so doing, the information received can contain an identification of flyer 17, which can be incorporated into flyer 17 in the background pixel information. This increases the wealth of information related to a customer/contact in the database. It is also possible to effect a new assignment of prototype classes and customer data. In addition, a new calculation could, for example, give rise to a new discount class or other new correlations important to a sales pitch which the salesperson can indicate to the customer as modified or customized offer options which had not previously been considered or printed on the individual printed product/flyer 17.

In place of recording new customer information, the ad customer can directly engage the salesperson in conversation about his/her individual ad proposals printed on individual printed product/flyer 17. The customer could, for example, change the color design or font sizes or any other ad parameter by means of notes made by the salesperson with pen 62. Any change which can be made on normal print sheets (printing proofs) is conceivable. Alternatively, the customer could simply accept the ad proposal outright.

All these actions comprise a written change to the original individualized printed product/flyer. The method would normally incorporate these changes into a feedback loop in Step 18 subsequent the personal discussion. To do so, it would be necessary for the salesperson to either give flyer 17 with the handwritten notes to another employee or to enter the changes directly into a computer system.

Since in this embodiment, the information is actually being fed back to the method and the method-realizing computer system as the sales meeting is still going on, reactions can be made accordingly fast—in real-time.

Based on the new information coming in from cell phone 63 and mobile communications network 64, a new evaluation 66 or a new order confirmation 66 or a further alternative proposal 66 can be made to the customer. In so doing, it would be additionally conceivable for an Editor to browse and assess the modified ad proposal, transmitted from the sales meeting to the computing center as described above, as to whether the modified ad proposal is feasible in relation to the desired changes. This information 66 from the computing center (e.g. new assignment of customer, new discount calculations, order confirmation, confirmation of ad changes, etc.) can then be automatically re-transmitted back through mobile communications network 64 to cell phone 63 of the salesperson holding the sales meeting with the customer. The information important to the salesperson is depicted on display screen 67 of cell phone 63. Feasible transmission options are SMS, MMS, email (e.g. ASCII, HTML, XML) or other transmission protocols/representations for structured and unstructured messages over portable or wired communication networks.

In this way, by recording on a piece of paper (individual printed product/flyer 17), the salesperson receives details, information and, as applicable, order confirmations during the sales pitch without human intervention. The salesperson could then print out an order confirmation on a portable printer (not shown) from the information from cell phone 63 such that he/she can immediately hand the customer the order confirmation on the ad or the like.

An example of a suitable individualized printed product/flyer 17 would be the present applicant's sales aid from its German patent application of Nov. 15, 2005.

A pen such as e.g. that from the Swedish firm Anoto can be used as electronic pen 62. The above-described interactive finction between the paper provided with the background pixel information and the electronic pen is known as Anoto functionality.

The method as presented is not limited to the selling of ads in business telephone directories. It is just as applicable for use during sales meetings in any number of other branches of industry. First and foremost to be additionally cited would be the financial services industry and the insurance industry. In principle, the method in accordance with the application can be used universally, wherever a salesperson is more or less required to provide personal consultation to a customer in order to customize an individual offer. This would also apply, for example, to the capital goods investment industry.

What is claimed is:

1. Method of producing individualized printed products by analyzing target person-relevant data utilizing machine learning comprising the steps of:
collecting individualized data,
evaluating the individualized data based on a learning classification process as well as generating an evaluation,
producing individualized printed products based on evaluation.

2. Method in accordance with claim 1, wherein the evaluating of the individualized data comprises the step of creating a number of prototype classes based on predefinable rules from the individualized data.

3. Method in accordance with claim 1, wherein the step of evaluating the individualized data contains the additional step of assigning target person-relevant data to the prototype classes created.

4. Method in accordance with claim 1, wherein the step of collecting the individualized data comprises the step of collecting structured and unstructured data and the two different types of data are also addressable in different data storages by means of at least one distinctive parameter.

5. Method in accordance with claim 4, wherein the structured and unstructured data contains information from telephone books, industry data, historic data, regional data, competitor data, in particular competitor telephone directory ads, company indicators, credit rating data and/or ad sales.

6. Method in accordance with claim 5, wherein the structured and unstructured data encompasses print and/or electronic media available online and/or offline.

7. Method in accordance with claim 1, wherein said printed products include individual presentation folders.

8. Method in accordance with claim 7, wherein said presentation folders contain printed information which takes a customer's individual situation into account, wherein the printed information is generated according to modifiable rules and based on priority valuation parameters and/or a printing template selection.

9. Method in accordance with claim 1, wherein the step of producing the individualized printed products encompasses the generating of at least two alternative proposal scenarios.

10. Method in accordance with claim 9, wherein said two alternative proposal scenarios include the proposal most likely to be accepted by a contractual partner.

11. Method in accordance with claim 1, wherein the further step of detecting success parameters comprises the use of the individualized printed products and the reversion to the step of recording individualized data.

12. Method in accordance with claim 11, wherein the step of evaluating the individualized information comprises a step of machine learning drawing on the temporal sequence of the utilization of the individualized printed products and of at least one success parameter with respect to the utilization of the printed products.

13. Method in accordance with claim 1, wherein the following further steps are included:
detecting changed or additional individualized data from individualized printed product by means of a pen which recognizes the detected data and saves same in pen,
forwarding the collected data to the step of evaluation on the individualized data or to the step of producing individualized printed products and the generating of at least one data value.

14. Method in accordance with claim 13, wherein the step of detecting changed or additional data is based on pixel information provided as background on the individualized printed product.

15. Method in accordance with claim 13, wherein forwarding of the detected data ensues by way of a portable communication device.

16. Method in accordance with claim 13, wherein the additional step is provided of transmitting the at least one data value generated to a mobile communication device.

17. Method in accordance with claim 16, wherein the at least one data value received from said mobile communication device is depicted on a display.

18. Computer system for realizing the method according to claim 1 having a mass storage, a workstation, an input/output station, communication devices to communicate within a computer network and at least one connected printing unit for generating individualized printed products or parts thereof.

19. Computer program product for implementing the method according to claim 1 on a computer system.
